(19) United States
(12) Patent Application Publication
(10) Pub. No.: US 2026/0152081 A1
(43) Pub. Date: Jun. 4, 2026

(54) INTEGRATED VARIABLE FLUX MEMORY MOTOR CHARGER

(71) Applicant: Jacobi Motors, LLC, Missouri City, TX (US)

(72) Inventors: Ahmed Morsy, Sugar Land, TX (US); Brian Wightman, Eugene, OR (US)

(73) Assignee: Jacobi Motors, LLC, Missouri City, TX (US)

(21) Appl. No.: 19/458,906

(22) Filed: Jan. 25, 2026

Related U.S. Application Data
(63) Continuation of application No. 18/388,330, filed on Nov. 9, 2023, now Pat. No. 12,558,980.

(51) Int. Cl. B60L 53/22; B60L 15/00; B60L 15/02; B60L 50/51; B60L 53/24; H02J 7/00; H02J 105/37; H02P 27/12

(52) U.S. Cl. CPC B60L 53/22; B60L 15/007; B60L 50/51; B60L 53/24; H02J 7/865; H02P 27/12; B60L 15/025; B60L 2220/14; H02J 2105/37

(57) ABSTRACT

An integrated synchronous motor charger includes a battery, and a synchronous motor having a set of phase windings, with each phase winding thereof having an open-ended winding configuration, the synchronous motor being electrically connected to the battery via a bidirectional inverter on a first end of at least one phase winding from the set of phase windings, and to a power source on a second end of the at least one phase winding. The synchronous motor is operably shiftable between a charging mode and a driving mode, the synchronous motor allowing electric power to flow bidirectionally between the power source and the battery in the charging mode, and allowing electric power to flow bidirectionally between the battery and the synchronous motor in the driving mode.

### BACKGROUND

Synchronous electric motors, such as Variable Flux Memory Motors or Wound Field Synchronous Motors, have a wide range of applications in industrial, commercial, and residential, applications, such as fans, pumps, compressors, elevators, and refrigerators, industrial machinery, and electric motor vehicles because of their high efficiencies. Also, because of using permanent magnets instead of windings in the rotors of the synchronous electric motors, there is less need for rotor cooling. These advantages along with others (e.g., being brushless) make the synchronous electric motors popular where high torque, high efficiency, or low maintenance for electric motors is needed.

Many applications require synchronous electric motors to operate on power supplied by batteries. A predominant example of such an application is an electric vehicle, where the motors are powered by rechargeable batteries. Such batteries may be periodically brought to a charging station that provides necessary electric power to charge the batteries. Usually, charging stations provide electric power in the form of single-phase or three-phase Alternating Current (AC), based on the distribution and transmission infrastructure associated with said charging stations.

Since batteries operate on Direct Current (DC), a rectifier (charger) is often used for converting the form of the electric power from AC to DC. Further, external filter inductors are added to the chargers to reduce variations in electric power, thereby ensuring improved efficiency when converting AC into DC. However, external filter inductors add weight and provide an additional point of failure in the charger. Some solutions propose repurposing of coils of the electric motors to function as inductor filters. However, motors generate torque or losses when they are excited with three-phase currents, which is undesirable during charging. Such charging currents also result in the demagnetization of permanent magnets (PM) on the rotors, resulting in a decrease in the motor performance. To use motors as inductor filters, particularly when used in conjunction with three-phase inverters, phase windings of the motor have to be center tapped with all nine terminals of the motor available for connection. In such configurations magnetic fields of the current passing therethrough get canceled out, whereby no torque is generated. However, such configurations lower the effective inductance which increases current ripples. Additionally, such configurations necessitate use of three H-Bridges (i.e. 6 phase inverter). Further, the complexity of such configurations also increases cost of assembling and maintaining, thereby making them less feasible.

In the case of a single-phase excitation, a motor that remains stationary generates a pulsating magnetic field as opposed to the rotating field generated in three-phase excitation scenarios. Consequently, if one or two phases of the motor function as an inductor filter, neither torque nor excessive motor losses are produced. Nevertheless, during single-phase AC/DC energy conversion, power pulses at twice the line frequency. The power flows to the battery should be smooth and devoid of ripples, necessitating a power decoupling mechanism. Existing decoupling mechanisms, however, require additional electronics, thereby contributing to the overall weight and cost of the system.

Therefore, there is a need for an integrated charger capable of charging batteries without generating undesirable torque. Further, there is a need for an integrated charger that displays adaptability concerning the receipt of either single-phase or three-phase electric power for the purpose of battery charging.

### SUMMARY

In an aspect, embodiments of the disclosure are directed towards an integrated synchronous motor charger. The charger includes a battery, and a synchronous motor having a set of phase windings, with each phase winding thereof having an open-ended winding configuration. The synchronous motor is electrically connected to the battery via a bidirectional inverter on a first end of at least one phase winding from the set of phase windings, and to a power source on a second end of the at least one phase winding. The synchronous motor is operably shiftable between a charging mode and a driving mode. The synchronous motor is configured to allow electric power to flow bidirectionally between the power source and the battery in the charging mode, and allow electric power to flow bidirectionally between the battery and the synchronous motor in the driving mode.

In another aspect, embodiments of the disclosure are directed to an integrated synchronous motor charger. The charger includes a battery, and a synchronous motor having a set of phase windings, with each phase winding thereof having an open-ended winding configuration. The synchronous motor is electrically connected to a bi-directional inverter on a first end of at least one phase winding from the set of phase windings, and to a power source on a second end of the at least one phase winding. The synchronous motor is operably shiftable between a charging mode and a driving mode. The synchronous motor is configured to allow electric power to flow bidirectionally between the power source and the battery in the charging mode, and allow electric power to flow bidirectionally between the battery and the synchronous motor in the driving mode. Further, the bi-directional inverter has an inverter bus capacitor that operably decouples the at least one phase winding from the set of phase windings to allow the synchronous motor to receive power from the power source in a plurality of phases.

Other aspects of the disclosure will be apparent from the following description and the appended claims.

### BRIEF DESCRIPTION OF THE DRAWINGS

FIG. 1 shows a block diagram of an integrated synchronous motor charger implemented in a vehicle, according to one or more embodiments.

FIG. 2A shows a circuit diagram of the integrated synchronous motor charger having a power decoupling means connected across two phase windings of a synchronous motor for receiving single-phase electric power, according to one or more embodiments.

FIG. 2B shows a circuit diagram of the integrated synchronous motor charger having the power decoupling means between at least one phase winding of the synchronous motor and a battery for receiving single-phase electric power, according to one or more embodiments.

FIG. 2C shows a circuit diagram of the integrated synchronous motor charger having an inverter bus capacitor and a buck-boost converter by connecting at least one phase winding of the synchronous motor to a battery for receiving single-phase electric power, according to one or more embodiments.

FIG. 2D shows a circuit diagram of the integrated synchronous motor charger adapted for receiving three-phase electric power, according to one or more embodiments.

FIG. 3 shows a circuit diagram of the integrated synchronous motor charger in a driving mode, according to one or more embodiments.

FIG. 4 shows a cross-section view of the Variable Flux Memory Motor (VFMM), according to one or more embodiments.

FIG. 5A shows a graphical plot of losses from the VFMM for current supplied thereto, according to one or more embodiments.

FIG. 5B shows a graphical plot of hysteresis behavior of soft magnets of the VFMM, according to one or more embodiments.

FIG. 5C shows a graphical plot of torque generated by the VFMM when electric power is supplied thereto, according to one or more embodiments.

### DETAILED DESCRIPTION

Specific embodiments of the disclosure will now be described in detail with reference to the accompanying figures. Like elements in the various figures are denoted by like reference numerals for consistency.

In the following detailed description of embodiments of the disclosure, numerous specific details are set forth in order to provide a more thorough understanding of the disclosure. However, it would have been apparent to one of ordinary skill in the art that the disclosure may be practiced without these specific details. In other instances, well-known features have not been described in detail to avoid unnecessarily complicating the description.

As used herein, “about” means approximately or nearly and in the context of a numerical value or range set forth means ±10% of the numeric value.

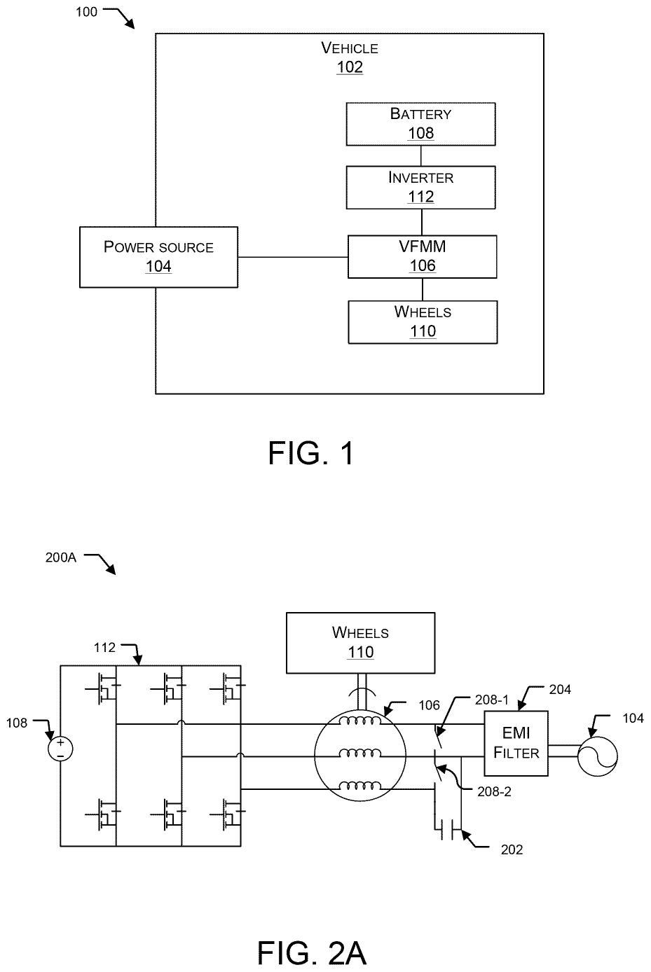

Referring to FIG. 1, a block diagram (100) of an integrated synchronous motor charger implemented in a vehicle (102) is illustrated. As shown, the charger may include one or more synchronous motors, such as Variable Flux Memory Motors (VFMMs) (106), each being configured to a corresponding set of wheels (110). In some configurations, the VFMMs (106) may be configured to propel the vehicle (102) by turning the wheels (110). Further, the charger may include a battery (108) that stores electric power received from a power source (104). While the present disclosure is described in the context of the charger being adapted for automotive implementations, it may be appreciated by those skilled in the art that the charger may also be suitably adapted for other non-automotive applications. Further, while the present disclosure is described in the context of the synchronous motors being VFMM, embodiments of the present disclosure may be suitably adapted for use in other synchronous motors, such as Wound field Synchronous Motor (WFSM).

In one or more embodiments, the vehicle (102) may include, but not be limited to, electric vehicle, hybrid vehicle, and the like. Examples of the vehicle (102)include, but not be limited to, two-wheelers, three-wheelers, cars, vans, trucks, buses, hydraulic vehicles, electric trains, locomotives, boats, ships, and the like. The vehicle (102) may include one or more components configured to provide one or more functionalities. In some embodiments, the components may be selected from a group including, but not limited to, an e-drive motor, staters of a combustion engine, a thermal heater, e-axles, inverters, exhaust pipes, batteries, chargers, compressors, variable frequency drive, and fuel cells associated with the vehicle (102). In some embodiments, the components may be powered by electricity. It may be appreciated by those skilled in the art that the charger may be implemented in any electrical system that requires a motor.

In one or more embodiments, the VFMMs (106) may be indicative of synchronous electric motors whose flux linkage (λm) may be dynamically, and operably, adjustable. The VFMMs (106) may be a type of synchronous motor in which magnetization of rotor magnets of the VFMMs (106) may be adjusted (i.e., changed) during an operation of the VFMMs (106). The adjustment of the magnetization of the rotor magnets (hereinafter, will be referred to as “VFMM magnetization” or “magnetization state” for simplicity) changes the torque generated therefrom when electric power is supplied to the VFMMs (106). According to one or more embodiments, to facilitate the change in the magnetization state of the VFMMs (106), the rotor magnets may be made of a soft-ferromagnetic material including, but not limited to, aluminum nickel cobalt (AlNiCo) or some types of ceramics. Hereinafter, the rotor magnets made of a soft-ferromagnetic material will be referred to as “soft magnets.” The soft magnets may be Low Coercive Force Magnets (LCF) that produce magnetomotive forces (mmf) when magnetized. According to one or more embodiments, the soft magnets may be AlNiCo with grades 1-9 or magnets made of AlNiCo, cast, ceramics, some grades of samarium cobalt, or sintered construction of these materials. It may be apparent to those skilled in the art that specific amounts of these materials may be used to achieve a desired function of the VFMMs (106). The design, construction, number, and arrangements of a stator, the rotor, and the soft magnets may the VFMMs (106) may be suitably adapted based on requirements of the use cases. In some examples, the VFMMs (106) may correspond to those provided in patent specifications WO2020210495A1, US20220407374A1, and/or WO2021081372A1.

The VFMMs (106), in accordance with one or more embodiments, are a better substitute for conventional synchronous motors due to their ability to be variably magnetized and demagnetized based on requirements. In one or more embodiments, the soft magnets can be quickly and efficiently magnetized and demagnetized while the soft magnets are assembled inside the motor. Accordingly, using VFMMs (106) potentially reduces manufacturing costs of electric motor-equipped systems due to being magnetized or demagnetized during assembly.

In one or more embodiments, the magnetization states of the soft magnets may be changed to any value from about 0% magnetization (i.e., the soft magnets are completely demagnetized) to about 100% magnetization (i.e., the soft magnets are magnetized to their maximum capacity). The change in the magnetization states may occur in a short time. In one or more embodiments, the magnetization states of the VFMMs (106) may be changed by passing a pulse of current therethrough such that the soft magnets are magnetized or de-magnetized up to the desired level. The level of magnetization of the soft magnets may be adjusted by amplitude of the pulse of current. By suitably adjusting the magnetization states of the VFMMs (106), the VFMMs (106) may be operably shifted between the charging mode and the driving mode. In some embodiments, the VFMMs (106) may allow electric power to flow bidirectionally between the power source (104) and the battery (108) in the charging mode. In such embodiments, the soft magnets may be demagnetized such that the VFMMs (106) are prevented from generating torque when the electric power is supplied thereto. Further, the VFMMs (106) may allow electric power to flow bidirectionally between the battery (108) and the VFMM (106) in the driving mode. In such embodiments, the soft magnets may be re-magnetized to allow the VFMMs (106) to generate torque. In embodiments where the synchronous motors are indicative of WFSM, a stator and a rotor thereof may be magnetically coupled. The intensity of magnetic fields of the rotor, and correspondingly the magnetic coupling between the stator and the rotor, may be manipulated by controllably varying electric current passed through the rotor.

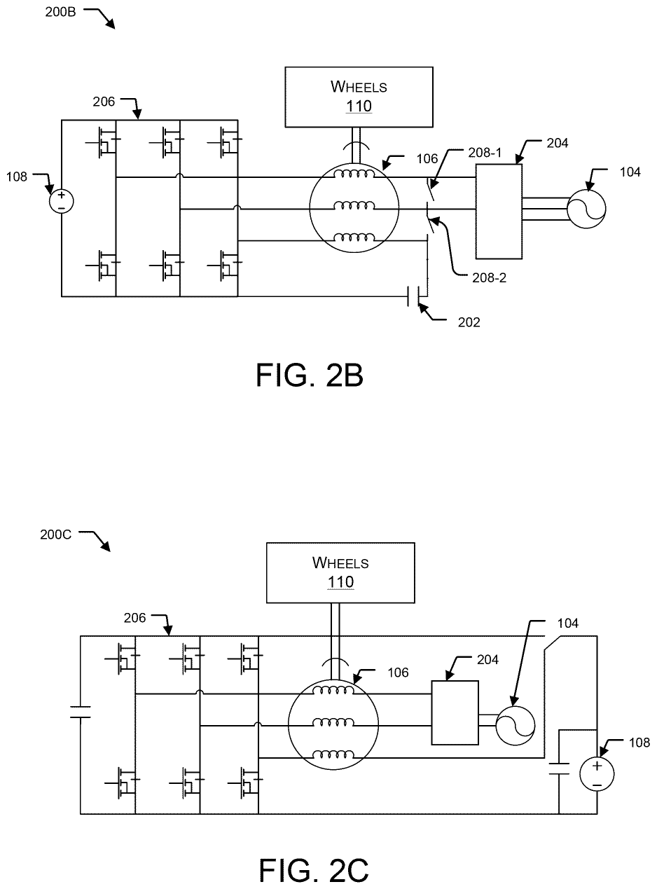

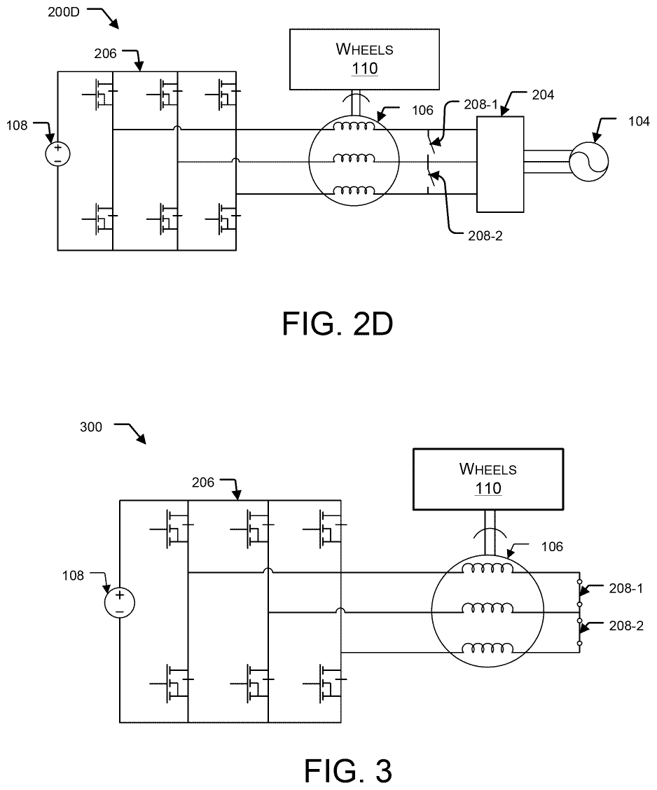

In one or more embodiments, the synchronous motors may have a set of phase windings. In some embodiments, each phase winding may have an open-ended winding configuration. In some embodiments, the set of phase windings may correspond to the coils on the stator of the VFMMs (106). In some embodiments, each of the phase windings may have a first end and a second end that are open, and do not form a closed circuit. In one or more embodiments, the synchronous motors may be electrically connected to the battery (108) via a bidirectional inverter, such as an inverter (112) shown in FIGS. 2A to 2D on the first end of at least one phase winding from the set of phase windings. In one or more embodiments, the synchronous motors may be electrically connected to the power source (104) on the second end of the at least one phase winding. In some embodiments, the synchronous motors may have 3 phase windings to operate with three-phase electric power supplied from the power source (104).

In one or more embodiments, the VFMMs (106) may include one or more coils wound on the stator. The one or more coils on the stator may correspond to the phase windings of the VFMMs (106). In embodiments where the soft magnets are demagnetized, the coils associated with the stator may provide inductive reactance to the electric power supplied thereto. Since the soft magnets are demagnetized, the VFMMs (106) may be prevented from generating torque or excessive losses when excited by the electric power from the power source (104). In some embodiments, the soft magnets may be demagnetized by passing the pulse of current through the coils associated with the stator. In such embodiments, the VFMMs (106) may operate as a filter inductor when receiving power from the power source (104), thereby reducing the current ripples due to switching of the inverter (112).

In one or more embodiments, in the charging mode, the bi-directional inverter (112) may convert the electric power from the power source (104) indicative of Alternating Current (AC) to Direct Current (DC) for charging the battery (108), or vice versa based on direction of flow of the electric power. In some embodiments, in the driving mode, the inverter (112) converts the DC from the battery (108) to the AC for actuating the synchronous motor, or vice versa based on direction of flow of the electric power. In some embodiments, the inverter (112) may be a multi-phase inverter. In an example, the multi-phase inverter may be a three-phase inverter. In other examples, the multi-phase inverter may be an inverter having more than one phase. In some embodiments, the inverter (112) may be electrically configured between the synchronous motors and the battery (108). In some embodiments, the inverter (112) may be used for re-magnetizing the soft magnets in the VFMMs (106) by controllably passing a pulse of electric current through the VFMMs (106).

In one or more embodiments, the power source (104) may be any power outlet capable of providing electric power either in single-phase or in three-phases. In some embodiments, the power source (104) may be connected to the grid. The form of the electric power supplied by the power source (104) may depend on the distribution or transmission infrastructure associated with the power source (104). In one or more embodiments, the charger may further include an Electro-Magnetic Interference (EMI) filter (204) that suppresses EMI. The EMI filter (204) may be configured between the power source (104) and the synchronous motor.

In embodiments where the power source (104) supplies single-phase electric power, the phase windings of the synchronous motors may be suitably adapted to receive power therefrom. In some embodiments, the charger may include a step-down transformer that lowers voltage of the electric power redirected to the battery (108). In such embodiments, the step-down transformer lowers the voltage of the electric power to a voltage below that of the battery (108). In an example, the battery (108) may have a voltage range of about 350V-400V.

Further, the charger may include a power decoupling means, such as a decoupling capacitor (202) shown in FIGS. 2A to 2C, that operably decouples one or more phase windings from the set of phase windings to allow the synchronous motors to receive power from the power source (104) in a plurality of phases. In some embodiments, the decoupling capacitor (202) may allow the synchronous motors to receive single-phase electric power from the power source (104). FIGS. 2A to 2C illustrate embodiments for decoupling the phase windings of the synchronous motor.

Referring to FIG. 2A, a circuit diagram (200A) of the charger having the power decoupling means connected across two phase windings of the synchronous motors are shown. When the synchronous motors have three phase windings, the power decoupling means may be configured across two of the three phase windings, thereby allowing the synchronous motors to receive single-phase electric power from the power source (104).

Referring to FIG. 2B, a circuit diagram (200B) of the charger having the decoupling capacitor (202) connected between at least one phase winding of the synchronous motors and the battery (108) is shown. As illustrated, in one or more embodiments, the decoupling capacitor (202) may be configured on the at least one phase winding from the set of phase windings on the second end of the synchronous motor. In such embodiments, the decoupling capacitor (202) may ground the at least one phase winding such that number of phase windings of the synchronous motors may be compatible with the phase of the electric power supplied by the power source (104). In an example, the decoupling capacitor (202) may be placed on a connection between the at least one phase winding and a negative terminal of the battery (108).

Further, referring to FIG. 2C, a circuit diagram (200C) of an alternative integrated synchronous motors charger having an inverter bus capacitor and a buck-boost converter by connecting at least one phase winding of the VFMM to a battery for receiving single-phase electric power is shown. In another aspect of the present disclosure, the integrated VFMM charger may include, the battery (108) and the synchronous motors having a set of phase windings. In some embodiments, each phase winding thereof may have an open-ended winding configuration. In such embodiments, the synchronous motors may be electrically connected to the bi-directional inverter (112) on the first end of at least one phase winding from the set of phase windings, and to the power source (104) on the second end of the at least one phase winding. In such embodiments, at least one phase winding from the set of phase windings may be connected to the bi-directional inverter (112) on the first end and the battery (108) on the second end.

Further, the bi-directional inverter (112), in such embodiments, may have an inverter bus capacitor that decouples the at least one phase winding from the set of phase windings to allow the synchronous motors to receive power from the power source (104) in a plurality of phases. If the power source (104) supplies single-phase electric power, two of the three phase windings of the synchronous motors may be decoupled to allow the synchronous motors to receive and filter the single-phase electric power, and redirecting the electric power to the battery (108) via the inverter (112).

In one or more embodiments, the charger may include a buck-boost converter configured on the at least one phase winding, the buck-boost converter being configured to lower voltage of the electric power to a voltage below that of the battery (108). In such embodiments, the charger may regulate the power flow to the battery (108), and cancel power ripples at double line frequency.

FIG. 2D shows a circuit diagram (200D) of the charger adapted for receiving three-phase electric power is illustrated. In such embodiments, the synchronous motors may receive the three-phase electric power from the power source (104), filter the electric power, convert the electric power to DC, and use the DC to charge the battery (108).

In the embodiments disclosed in FIGS. 2A to 2D, the soft magnets of the VFMMs (106) may be demagnetized, thereby allowing the VFMMs (106) to operate as filter inductors. Demagnetizing the soft magnets may also prevent the VFMMs (106) from generating torque when the electric power is passed therethrough for filtering.

In typical implementations of the inverter (112), when the synchronous motors consume power from the battery (108) in the driving mode, the synchronous motors may convert electrical power to kinetic energy. In other embodiments, the inverter (112) may be adapted for providing regenerative braking functionality. In such embodiments, the synchronous motors may be operably shifted to a regenerative charging mode, where the synchronous motors may be adapted to convert kinetic energy into AC. The AC may be transmitted through the bi-directional inverter (112) that converts the AC to DC for charging the battery (108). In some embodiments, the charger may further include the power decoupling means that decouples one or more phase windings from the set of phase windings such that number of phase windings of the synchronous motors may be compatible with the bi-directional inverter (112). In some examples, the power decoupling means may decouple two of the three phase windings of the synchronous motors such that said synchronous motors are made compatible with a single-phase inverter (112), thereby further reducing size and weight of the inverter (112).

FIG. 3 shows a circuit diagram (300) of the integrated VFMM charger in the driving mode, according to one or more embodiments. As shown, the synchronous motors may be closed off from the power source (104) by a first and a second switch (208-1, 208-2) (collectively referred to as switches 208). In one or more embodiments, further may include one or more switches that operably shift the synchronous motors between the charging mode and the driving mode.

In one or more embodiments, the switches (208) may be configured on the set of phase windings between the synchronous motors and the power source (104). In some embodiments, the switches (208) may be operably closed to form a star connection such that the synchronous motors may be disconnected from the power source (104), thereby shifting the synchronous motors to the driving mode. In such embodiments, the synchronous motors may form a closed circuit with the battery (108), and consume power therefrom. The inverter (112) may be configured to convert the DC from the battery (108) to the AC of the required phase for the synchronous motors to consume. In one or more embodiments, one or more switches (208) may be opened to shift the synchronous motors to the charging mode.

In one or more embodiments, the charger may include the switches (208) configured between the synchronous motors and the power decoupling means. In such embodiments, the charger may operably engage or disengage the decoupling capacitor (202) to move between configurations in either FIGS. 2A and 2B, and FIG. 2D, based on the phase of the electric power supplied by the power source (104).

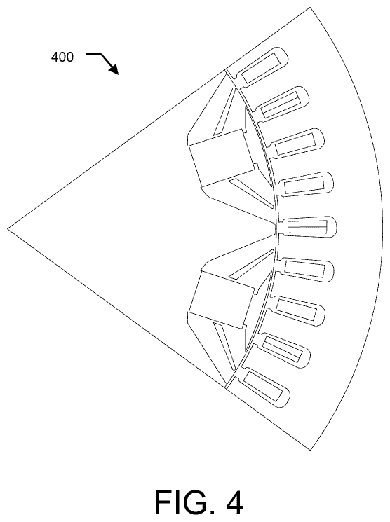

FIG. 4 shows a cross-section view (400) of the VFMMs (106), according to one or more embodiments. As shown, when the soft magnets of the VFMMs (106) are demagnetized, the VFMMs (106) may be prevented from generating a magnetic field, and, in turn, be prevented from generating torque. In such embodiments, the rotor may be locked in position, thereby allowing the electric power to be filtered without risk of generating torque during charging.

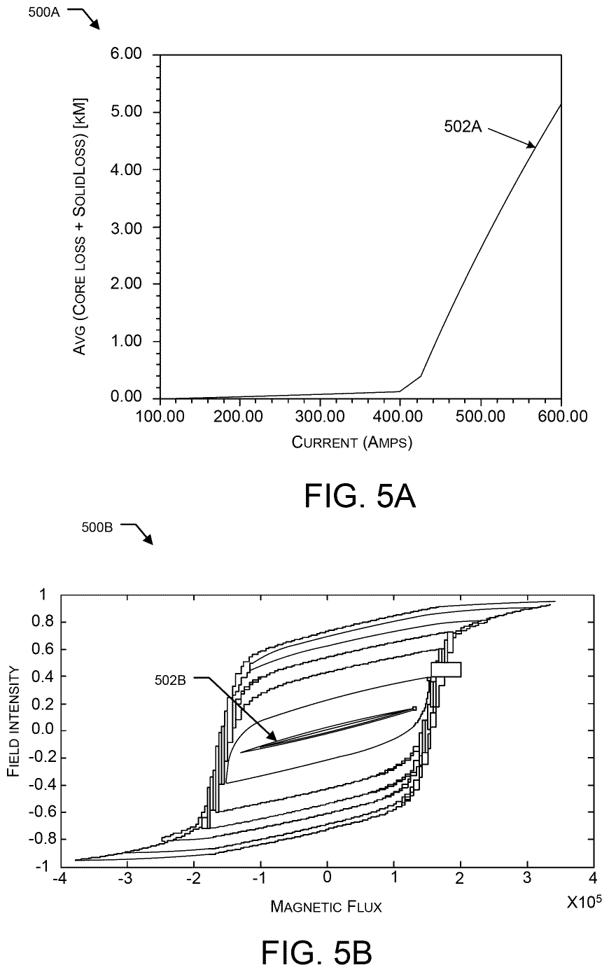

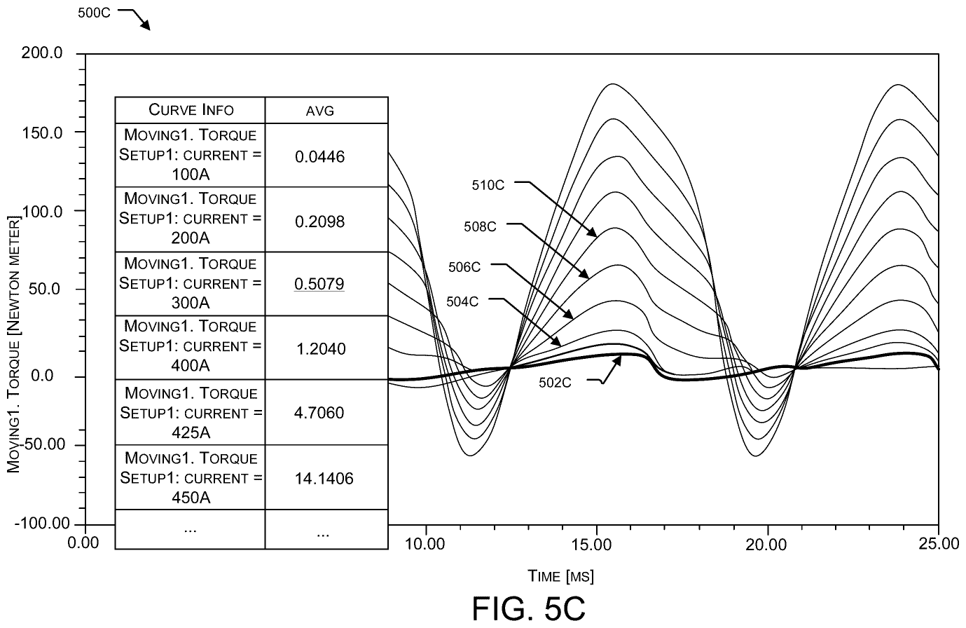

FIG. 5A shows a graphical plot (500A) of losses from the VFMMs (106) for current supplied thereto, according to one or more embodiments. The graphical plot (500A) shows a line (502A) indicating the losses at a plurality of magnitudes of the electric current, when the soft magnets are demagnetized. As shown, the losses may be below a predetermined acceptable threshold, when the magnitude of electric current supplied thereto is less than a threshold level. The losses may increase beyond the acceptable threshold as the electric current increases, beyond which the losses may no longer be acceptable. In a preferred example, the losses may be below the acceptable threshold when the electric current is less than about 400A.

FIG. 5B shows a graphical plot (500B) of hysteresis behavior of soft magnets of the VFMMs (106), according to one or more embodiments. The graphical plot particularly shows the hysteresis behavior of soft magnets made of AlNiCo. As shown, the magnetic hysteresis loops may indicate the field intensity (H) and the magnetic flux (B) oscillates around 0 in a straight line as shown by region (502B), when the electric current is sufficiently low, i.e. less than about 400A.

FIG. 5C shows a graphical plot (500C) of developed torque from the VFMMs (106) for the electric power supplied thereto, according to one or more embodiments. The graphical plot is indicative of a torque plot of the torque generated by the VFMMs (106) with respect to the electric power supplied thereto. As shown, the line plots (502C to 510C) correspond to torques generated at electric currents at 300A, 400A, and at 25A increments from 400A respectively, within a predetermined interval. The torque generated at up to about 400A is acceptably low for providing charging functionality, and hence may form the preferred ranges for the electric current.

The use combination of the inverter (112) and the VFMMs (106) in conjunction with the other may allow for charging functionality with a simpler circuit design that requires minimal electronics. Further, the charger of the present disclosure minimizes the weight and complexity of the circuit design thereof, and eliminates need for external inductors. Furthermore, the charger provides for means for charging batteries with both single-phase, as well as three-phase electric power from the power source (104).

While the disclosure has been described with respect to a limited number of embodiments, those skilled in the art, having benefit of this disclosure, will appreciate that other embodiments can be devised which do not depart from the scope of the disclosure as disclosed herein. Accordingly, the scope of the disclosure should be limited only by the attached claims.

What is claimed is:

1. A vehicle having an integrated unit, the integrated unit operating with a battery for storing power from a power source, the integrated unit comprising:
at least one synchronous motor having at least one set of phase windings;
at least one bidirectional inverter operably coupled with a first end of the at least one set of phase windings and with the battery; and
wherein a second end of the at least one set of phase windings is operably coupled with the power source; and
wherein the at least one synchronous motor being operably shifted between a charging mode and a driving mode, the synchronous motor operably allowing the power to flow bidirectionally between the power source and the battery in the charging mode, and operably allowing the power to flow bidirectionally between the battery and the synchronous motor in the driving mode.

2. The vehicle of claim 1, wherein the at least one synchronous motor operably propels at least one wheel.

3. The vehicle of claim 2, wherein the at least one synchronous motor being operably shifted between the charging mode and the driving mode by adjusting a magnetization of the synchronous motor.

4. The vehicle of claim 3, wherein the at least one synchronous motor being operably shifted between the charging mode and the driving mode by at least one switch, the at least one switch operably forming a star connection.

5. The vehicle of claim 3, wherein the at least one synchronous motor comprises at least one rotor having a magnetization operably adjusted by passing a pulse to magnetized or de-magnetized the at least rotor magnet.

6. The vehicle of claim 5, wherein the magnetization being operably adjusted by controlling an amplitude of the pulse.

7. The vehicle of claim 6 wherein the at least one synchronous motor comprises at least one of a Variable Flux Memory Motor (VFMM) or a Wound Field Synchronous Motor (“WFSM”).

8. The vehicle of claim 7, wherein the at least rotor magnet comprises a soft-ferromagnetic material.

9. The vehicle of claim 8, wherein the soft-ferromagnetic material magnet of the at least one synchronous motor, in the charging mode, being operably demagnetized to prevent torque generation caused by the flow of the power.

10. The vehicle of claim 8, wherein the soft-ferromagnetic material magnet of the at least one synchronous motor, in the driving mode, being operably re-magnetized to enable torque generation.

11. The vehicle of claim 7, wherein the at least one synchronous motor further comprises a stator being magnetically coupled with the rotor, and an intensity of the magnetically coupling being operably manipulated by varying a current passed through the rotor.

12. The vehicle of claim 7, wherein the at least one synchronous motor comprises a 3-phase windings to operable couple with the power source having a three-phase configuration.

13. The vehicle of claim 7, wherein the at least one synchronous motor comprises at least one coil wound on the stator, the at least one coil corresponding with the at least one set of phase windings, and the at least one coil operably creating an inductive reactance to the power if the soft magnets are demagnetized.

14. The vehicle of claim 13, wherein the at least one synchronous motor being to operably prevented from generating torque if the at least one coil operably creates an inductive reactance.

15. The vehicle of claim 7, wherein the at least one synchronous motor being operably configured to act as a filter inductor when receiving power from the power source.

16. The vehicle of claim 7, wherein the bi-directional inverter operably converts the power from the power source indicative of Alternating Current (AC) to Direct Current (DC) for charging the battery.

17. The vehicle of claim 7, further comprising a step-down transformer that operably lowers the power flow to the battery.

18. The vehicle of claim 7, wherein the bi-directional inverter comprises:
at least one inverter bus capacitor; and
at least one buck-boost converter, the buck-boost converter operably coupling at least one phase
winding of the set to the battery to operably receive single-phase power.

19. The vehicle of claim 18, wherein the at least one inverter bus capacitor operably decouples the at least one phase winding of the set and operably allowing the synchronous motors to receive power from the power source in a plurality of phases.

20. An integrated charging unit operating with a battery for storing power from a power source, the integrated charging unit comprising:
at least one Variable Flux Memory Motor (VFMM) having at least one set of phase windings, the at
least one VFMM comprises at least one rotor having a magnetization operably adjusted by passing a
pulse to magnetized or de-magnetized the at least rotor, the at least one VFMM being operably
shifted between a charging mode and a driving mode corresponding with magnetization of the at
least one rotor;
at least one bidirectional inverter operably coupled with a first end of the at least one set of phase windings and with the battery, the at least one bidirectional inverter comprising:
at least one inverter bus capacitor; and
at least one buck-boost converter, the buck-boost converter operably coupling at least one phase winding of the set to the battery to operably receive single-phase power;
wherein a second end of the at least one set of phase windings is operably coupled with the power source; and
wherein the at least one VFMM operably allowing the power to flow bidirectionally between the
power source and the battery in the charging mode, and operably allowing the power to flow
bidirectionally between the battery and the at least one VFMM in the driving mode.
